(19) United States
(12) Patent Application Publication
(10) Pub. No.: US 2016/0373388 A1
(43) Pub. Date: Dec. 22, 2016

(54) MESSAGING APPLICATION FOR RECORDING AND INSERTING A VIDEO MESSAGE INTO A CHAT

(71) Applicant: Voxer IP LLC, San Francisco, CA (US)

(72) Inventors: Thomas E. KATIS, Jackson, WY (US); Irvin J.F. REMEDIOS, San Francisco, CA (US); Edmond B. AU, Pleasanton, CA (US); Kostiantyn DOMBROVSKYI, Walnut Creek, CA (US); Michal VASKO, Palo Alto, CA (US)

(21) Appl. No.: 14/802,167

(22) Filed: Jul. 17, 2015

Related U.S. Application Data
(60) Provisional application No. 62/182,362, filed on Jun. 19, 2015.

(51) Int. Cl. H04L 12/58; H04W 4/00; H04L 29/06

(52) U.S. Cl. CPC H04L 51/10; H04L 65/604; H04W 4/001; H04W 4/005

(57) ABSTRACT

A messaging application, intended to run on a communication device, that is capable of recording a video clip in response to a predefined motion of the mobile communication device. When the messaging application is opened, and the predefined motion is sensed, a video module included in the messaging application is activated, enabling the recording, saving and insertion of a video message containing the video clip into a messaging chat. In a specific, but non-exclusive embodiment, the predefined motion is a rotation of the communication device from a portrait orientation to a landscape orientation. In other embodiments, other predefined motions may be used.

### CROSS-REFERENCE TO RELATED APPLICATIONS

This application claims the benefit of priority under 35 USC §119(e) to U.S. Provisional Patent Application No. 62/182,362 filed Jun. 19, 2015, entitled “MESSAGING APPLICATION FOR RECORDING AND INSERTING A VIDEO MESSAGE INTO A CHAT,” which is incorporated herein by reference in its entirety for all purposes.

### BACKGROUND

Field of the Invention

The present invention relates to messaging applications executed on mobile communication devices, and more particularly, to a messaging application capable of recording a video clip in response to a predefined motion of the mobile communication device, creating a video message containing the video clip, and then inserting the video message into a string of one or more messages of a messaging chat between participants.

Description of Related Art

In recent years, mobile communications has become exceedingly popular. More and more people are using mobile communication devices, such as smart phones and tablets, on a daily basis. One extremely popular application with smart phones and tablets is messaging. With messaging, an application must be either preloaded or downloaded onto the device. Once the messaging application is installed, it allows the device user to participate in one or more messaging chats with other participants. Within the context of each chat, the participants may send and receive messages. In addition, for each chat, the messaging application typically provides a message history of all the exchanged messages between the participants.

Smart phones and tablets typically include a video camera that allows a user to record and save a video. Most smart phones and tablets also allow a saved video to be shared. For example, after a video has been recorded and saved, the activation of a “share” function (e.g., a share icon) enables the user to send the video to others. Typically, when the share icon is selected, options to either email or message the video are provided. When email is selected, an email is created from an existing email account and the user is then prompted to enter the email address of the intended recipient(s). The video is then sent to the recipient(s) as an attachment to the email. On the other hand when messaging is selected as the delivery option, then a message is created, including the video attachment, using an existing messaging application on the device. The user is then prompted to enter a cell phone number and/or contact for the intended recipient(s). If the entered contact is a participant of an existing chat, then the message including the video is sent and added to the existing chat history. If the contact is not already part of an existing chat, then a new chat is created between the sending and receiving parties and the message with the video is sent. In either case, the recipient may review the video by activating a “play” icon that appears or is superimposed over the video contained in the message.

With certain smart phones, such as the iPhone 6 by Apple, the iMessage application has the ability to record a video clip and send a message including the clip as a message in the context of a chat. With the iMes sage application, a user is required to open the application, enter into a chat, and then select an icon of a camera. In response, the user is prompted with a choice to either snap a photo or record a video. If the latter option is selected, then a video clip may be recorded. When the recording is complete, the user is again prompted and asked if they wish to include the video in the chat. If the answer is yes, then a message is created including the video chat. The user is then prompted to enter a “send” command, which results in the message being sent to the chat participants and including in the history of the chat.

The aforementioned examples for capturing and adding a video to a messaging chat are very inefficient and cumbersome. In both cases, the process is highly manually, requiring the user to sequence through a number of steps and enter various commands to (a) record a video clip, (b) incorporate the video clip into a message, (c) insert the message into a message history of a chat, and then (d) send the message to the participants of the chat. Consequently, an easier, more elegant, way for creating, saving and sending video clips within the context of a messaging application is therefore needed.

### SUMMARY OF THE INVENTION

The present invention is directed to a messaging application, intended to run on a communication device, that is capable of recording a video clip in response to a predefined motion of the mobile communication device. When the messaging application is opened, and the predefined motion is sensed, a video module included in the messaging application is activated, enabling the recording, saving and insertion of a video message containing the video clip into a messaging chat. In a specific, but non-exclusive embodiment, the predefined motion is a rotation of the communication device from a portrait orientation to a landscape orientation. In other embodiments, other predefined motions may be used.

In other non-exclusive embodiments, the video module optionally includes a record function for selectively recording the video clip, a preview function for selectively previewing the recorded video clip, and a save function that automatically saves and inserts the video message containing the video clip into the string of one or more messages of the messaging chat.

In yet other non-exclusive embodiments, the messaging application may include a chat selection module for inserting the video message containing the video clip into one or more selected chats respectively. The messaging application may also include a contact selection module for selecting one or more contacts, among a list of contacts, and sending the video message containing the video clip to the selected one or more contacts.

### BRIEF DESCRIPTION OF THE DRAWINGS

The invention may best be understood by reference to the following description taken in conjunction with the accompanying drawings, which illustrate specific embodiments of the invention.

FIG. 1 is a logic block diagram of a non-exclusive embodiment of a communication device configured to run a messaging application in accordance with the principles of the present invention.

FIGS. 2A through 2G are an exemplary series of diagrams illustrating operation of a messaging application in accordance with the principles of the present invention.

FIG. 3 is an exemplary diagram illustrating how a video message containing a recorded video clip can be created and inserted into one or more chats of a messaging application in accordance with a non-exclusive embodiment of the present invention.

FIG. 4 is an exemplary diagram illustrating how a video message containing a recorded video clip can be created sent to one or more contacts of a messaging application in accordance with another non-exclusive embodiment of the present invention.

FIG. 5 is a flow diagram illustrating operational steps of the messaging application in accordance with a non-exclusive embodiment of the present invention.

It should be noted that like reference numbers refer to like elements in the figures.

The above-listed figures are illustrative and are provided as merely examples of embodiments for implementing the various principles and features of the present invention. It should be understood that the features and principles of the present invention may be implemented in a variety of other embodiments and the specific embodiments as illustrated in the Figures should in no way be construed as limiting the scope of the invention.

### DETAILED DESCRIPTION OF SPECIFIC EMBODIMENTS

The invention will now be described in detail with reference to various embodiments thereof as illustrated in the accompanying drawings. In the following description, specific details are set forth in order to provide a thorough understanding of the invention. It will be apparent, however, to one skilled in the art, that the invention may be practiced without using some of the implementation details set forth herein. It should also be understood that well known operations have not been described in detail in order to not unnecessarily obstruct the invention.

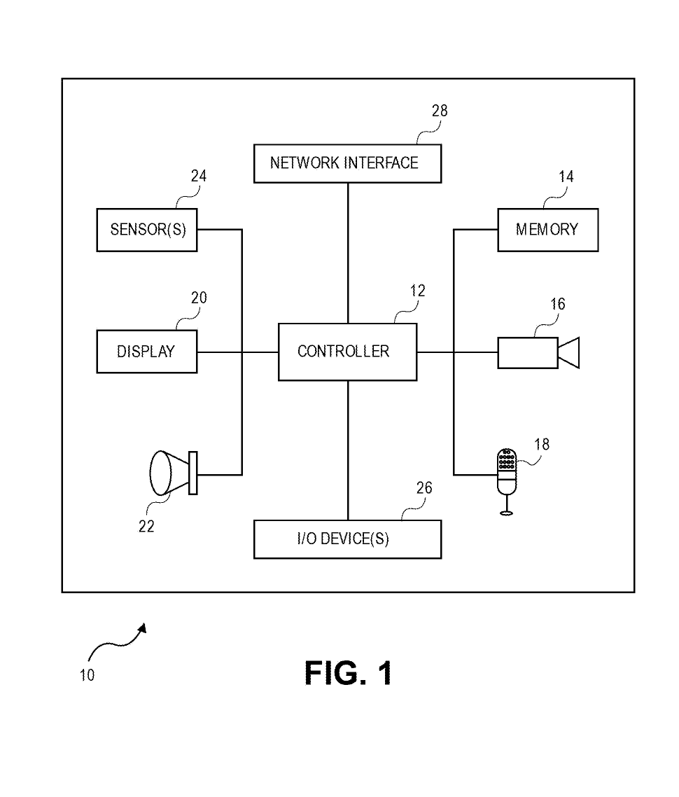

Referring to FIG. 1, a block diagram of a non-exclusive embodiment of a communication device 10 configured to run a messaging application in accordance with the principles of the present invention is shown. The communication device 10 includes a controller 12 such as a CPU, memory 14, a still and/or video camera 16, a microphone 18, a display 20 which may optionally be touch-sensitive, a speaker 22, one or more sensors 24, such as but not limited to a gyroscope, an accelerometer, or any other type of sensor capable of detecting the motion of the device 10, one or more input/output (I/O) devices 26, such as a physical keyboard or a virtual keyboard which operates in cooperation with display 20, scroll button(s), push button(s), a headset, etc., and a network interface 28, which is provided to connect the device 10 to a wired or wireless network. As the operation of all of the elements 12 through 28 are well known, a further explanation is not provided herein.

In one embodiment, the device 10 may be a mobile device, such as a smart phone or tablet. For example, the device 10 may be a mobile phone or tablet such as those designed for the iOS by Apple, Android by Google, or similar operating systems by Blackberry, Microsoft, or any other operating system platform. In an alternative embodiment, the device 10 can be a desktop or laptop computer running the messaging application, either through a Web browser or as a native application.

The communication device 10 is configured to run the messaging application, which is implemented in computer code, stored in memory 14, and executed by the controller 12. The user interacts with the messaging application using the elements 16 through 28 in a well-known manner. In various embodiments, the messaging application may be capable of transmitting and/or receiving messages containing one or more of the following types of media, including voice, text, photos, GPS or positional data, or other types of data.

For the sake of illustration, the present invention is described within the context of the Voxer® messaging application, distributed by the assignee of the present application. Voxer is a progressive, store and forward, messaging application designed to operate on smart phones, tablets and computers. As a progressive application, outgoing “Vox” messages are progressively stored and progressively transmitted by the sending device as the media of the message is created. Incoming Vox messages are also progressively stored on a receiving device as the media is received over the network. With the progressive processing and storage of media, Voxer allows users to selectively render incoming Vox messages in either near real-time as the media is received over the network or in a time-shifted mode by rendering the message out of storage. Voxer also has the ability to allow users to create and participate in one or more chats with other Voxer users by semantically threading together the exchanged Vox messages between two or more participants. With the storage of messages threaded together into chats, the users of Voxer can transition between chats for participation and have the ability to review the history of each of the chats when convenient.

Voxer is also capable of operating in both a half-duplex and a full-duplex mode. In other words, a communication device running Voxer is capable of both sending and receiving Vox messages at the same time. In situations when two Vox users are sending and rendering received messages from one another at substantially the same time, the user experience is similar to that of a conventional, synchronous, telephone call. On the other hand when the two users are sending messages back and forth at discrete times, then the user experience is similar to time-shifted messaging.

Yet another advantage of Voxer is that Vox messages are not limited to voice media. On the contrary, Vox messages may include one or more types of media, including voice, text, photos, GPS or positional data, or other sensor data.

Finally, Voxer provides the advantages of guaranteed delivery of Vox messages. Besides the progressive storage of Vox messages on transmitting and receiving devices, Voxer also provides for the progressive storage of Vox messages on the network. As a result, messages can be transmitted out of storage by a transmitting device in situations when network conditions are poor or non-existent when the message was created or transmitted out of storage on the network if the recipient was not available when the message was created and transmitted. In addition, Voxer uses transmission protocols that ensure the delivery of complete messages. For more details regarding the Voxer application, see commonly assigned U.S. Pat. No. 8,902,749, incorporated herein for all purposes.

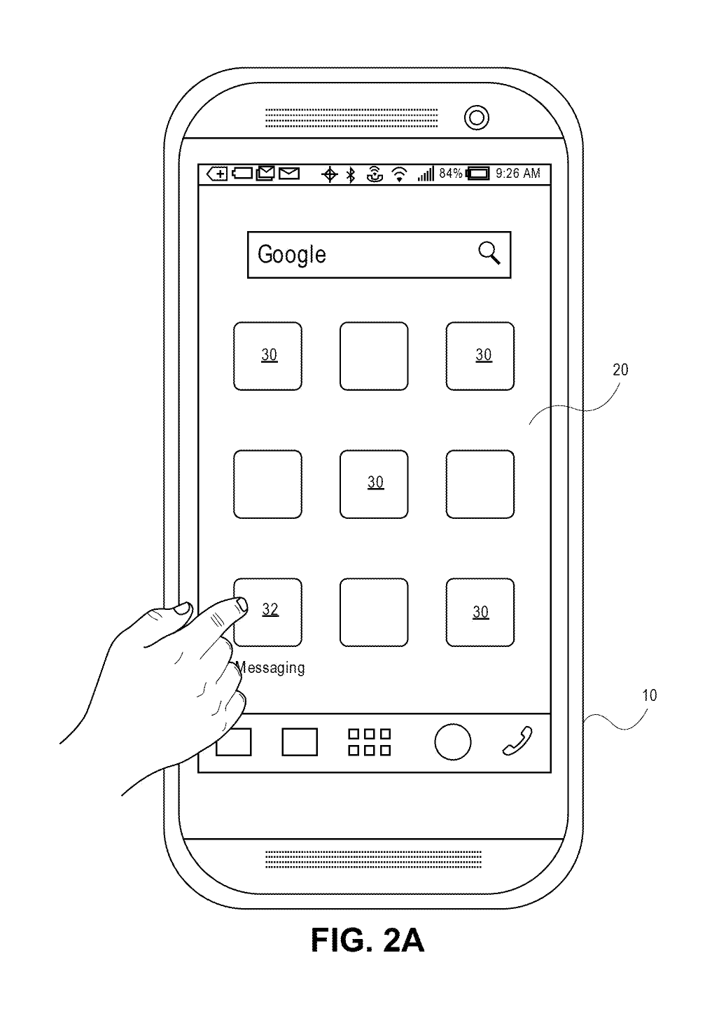

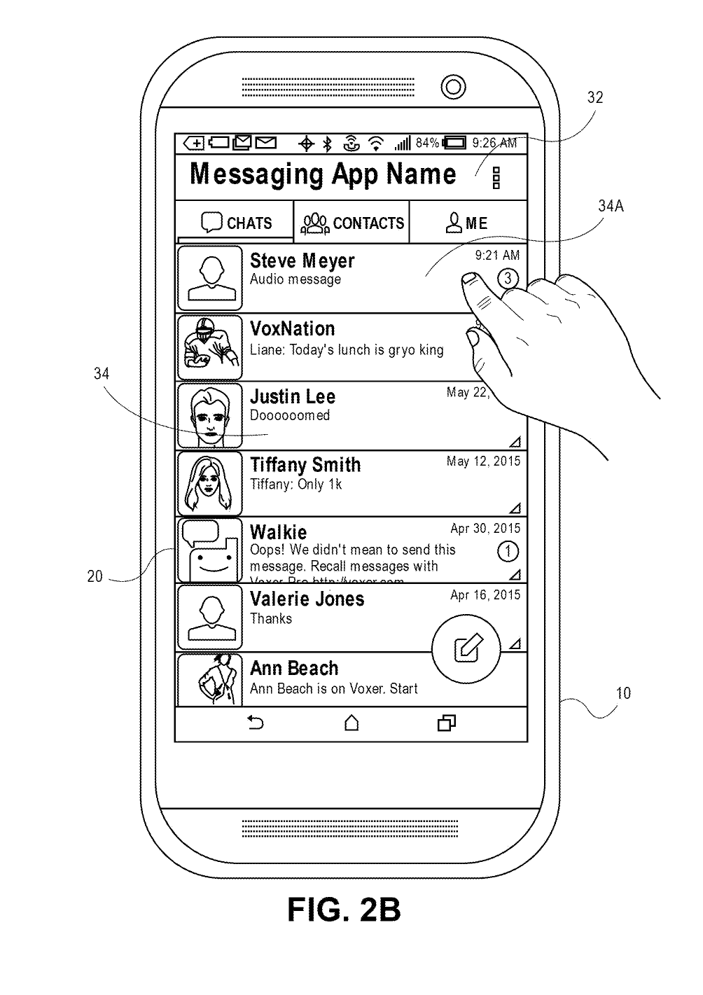

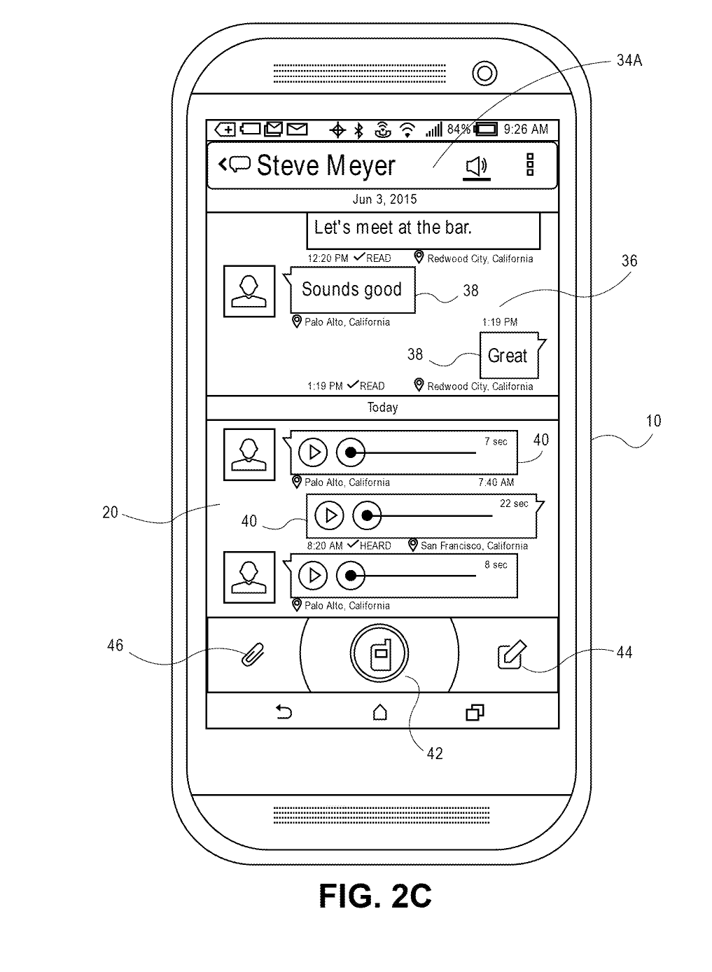

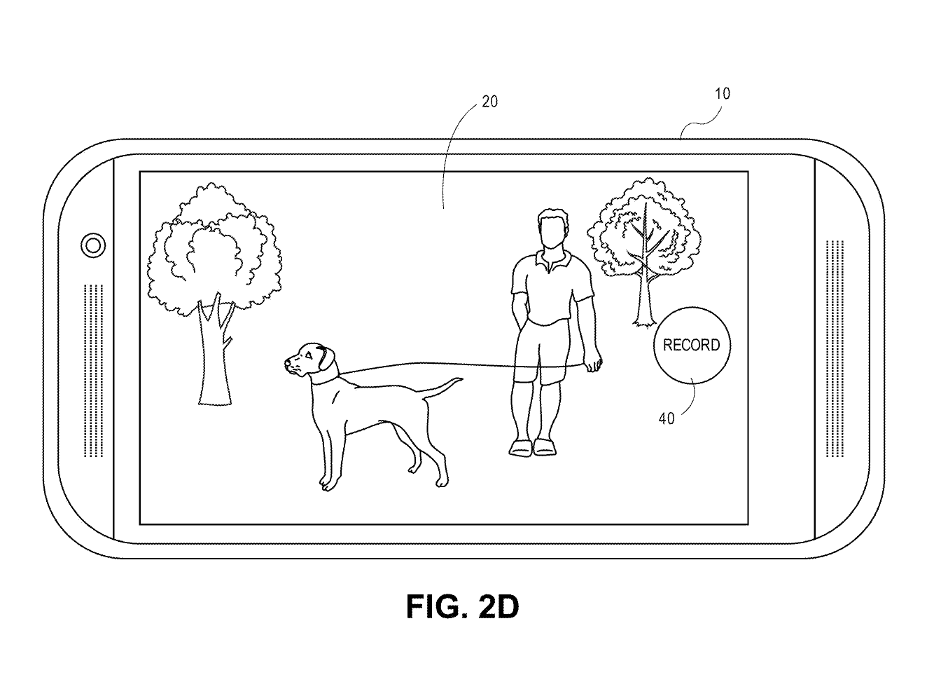

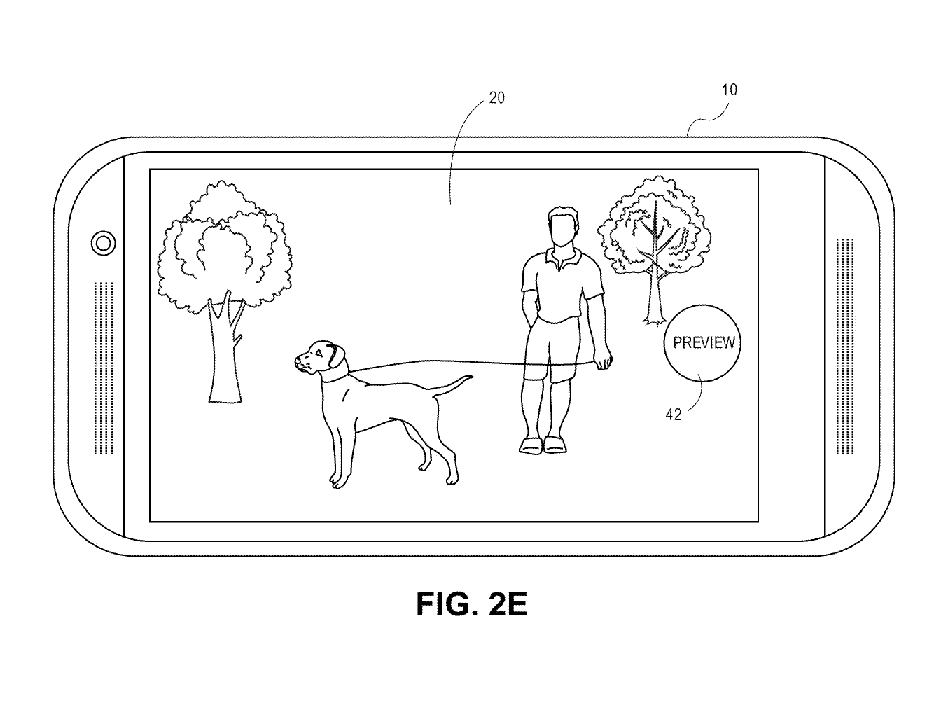

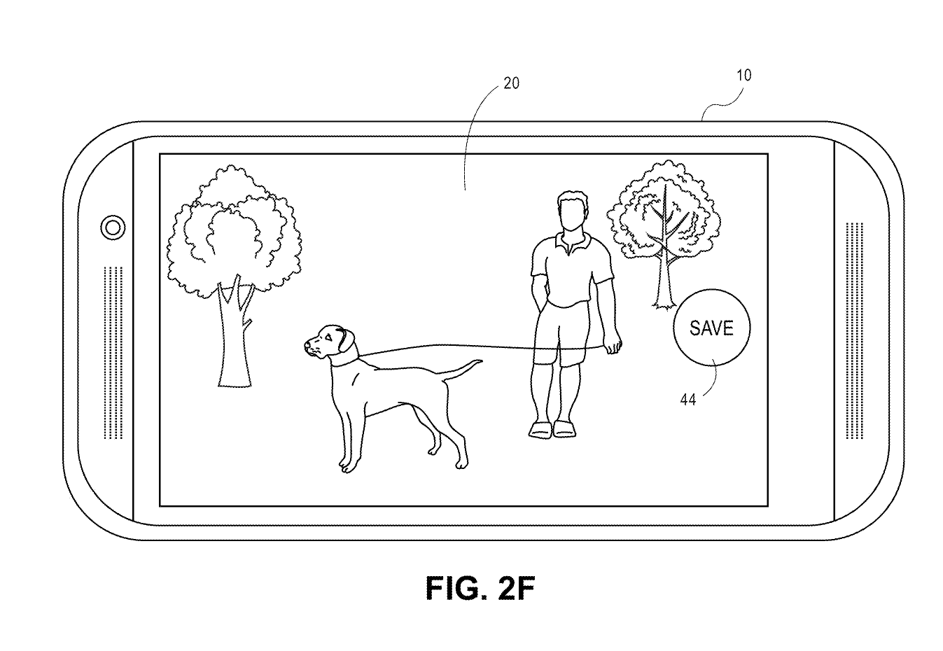

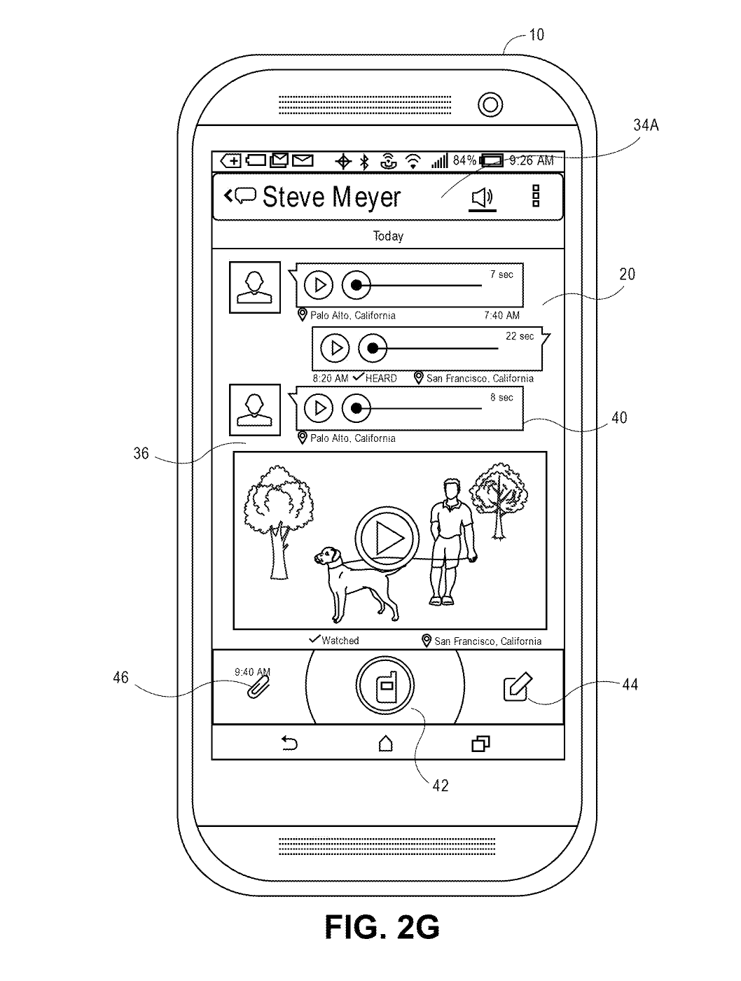

Referring to FIG. 2A through FIG. 2G, an exemplary series of diagrams illustrating operation of a messaging application in accordance with the principles of the present invention are shown. In particular, these figures illustrate a sequence of diagrams illustrating how a video clip is created, inserted into a video message, and then added into a chat, all within the context of a messaging application.

In FIG. 2A, an exemplary home screen appearing on the display 20 of the computing device 10 is illustrated. In this example, the home screen includes a number of icons 30 that are representative of a number of applications loaded onto the device 10. Relevant to the present application, the figure shows a user of the device 10 selecting a messaging application 32 (such as but not limited to the Voxer application), which causes the messaging application to open and run on the device 10.

In FIG. 2B, after the messaging application 32 is opened, a number of active chats 34 appear on the display 20. In this particular example, the user of the device 10 would like to record a video clip and send a video message containing the clip to Steve Meyer. To do so, the user selects the chat 34A that bears Steve Meyer's name, which causes the history of this conversation to be displayed.

In FIG. 2C, a message history 36 of the chat 34A with Steve Meyer appears on the display 20. In this particular example, the chat history includes a mix of both text messages 38 and voice messages 40 in the time-order in which each was added to the conversation. In addition, a number of icons appear near the bottom of the display 20. These icons allow the user of the device to contribute various types of messages to the chat 34A. For example, the “PTT” icon 42 allows the user to create a new voice message 40 that is added to the message history 36 of the chat 34A. The text icon 44 enables the user to create and add a text message to the message history 36 of the chat 34A. The attachment icon 46 enables the user to add a message containing an attachment, such as a document or photo, to the message history 36 of the chat 34A. Again, the icons 42, 44 and 46, while specific to the Voxer application, should not be construed as limiting. Other messaging applications may or may not have analogous functionality.

In one non-exclusive embodiment, the ability to record a video clip and automatically insert a video message containing the video clip into a chat history is invoked by a predetermined motion of the device 10. In one non-exclusive embodiment, the predetermined motion is a rotation of the device 10 from a portrait orientation to a landscape orientation. When the predetermined motion is sensed by the sensor(s) 24, a video module of the messaging application 32 activates the video camera 16 of the device 10. As a result, the scene captured by the video camera 16 appears on the display 20.

Referring to FIG. 2D, the device 10 is illustrated after the predetermined motion has been detected and the video camera 16 has been activated. In this particular example, the scene captured by the camera 16 is of a man walking a dog. By contacting the record icon 40 appearing on the display 20, a video clip of the scene is recorded for the duration the record icon 40 is activated. For example if the record icon is pressed for 10 seconds, then the video clip will be 10 seconds long. Once the icon 40 is released, the recording stops.

Referring to FIG. 2E, the device 10 is illustrated after recording icon 40 is released. In an optional embodiment, a preview icon 42 appears on the display 20. By selecting the preview icon 42, the recorded video clip can be played. This feature thus allows the user of the device 10 to review the video clip and decide if it should be included in a message added to a chat or not.

Referring to FIG. 2F, the device 10 is illustrated after either the recording icon 40 is released and/or alternatively the video clip has been previewed. In either case, a save icon 44 appears. When the save icon 44 is selected, the video clip is automatically inserted into a video message 46, the video message 46 is sent to the chat participant (e.g., Steve Meyer) of the active chat 34A, and the video message 46 is added to the message history 36 of the chat 34A.

Referring to FIG. 2G, the video message 46 is shown in the message history 36 of the chat 34A with Steve Meyer. The aforementioned video module of the messaging application 32 is thus responsible for inserting the video message 46 containing the video clip into the string of messages of the messaging chat 34A.

In variations of the above-described embodiment, the message history 36 of chat 34A, including the video message 36, automatically appears on the display 20 after the save icon 44 is selected. Alternatively, the message history 36, including the video message 44, will appear on the display 20 after the predetermined motion is reversed (e.g., the device 10 is rotated from landscape back to portrait).

The above-described sequence describes how a video message is automatically inserted into an active chat (e.g., 34A with Steve Meyer). In alternative embodiments, however, a recorded video clip can also be added to a message and sent to participant(s) of other non-active chats or even contacts of the user of the device 10.

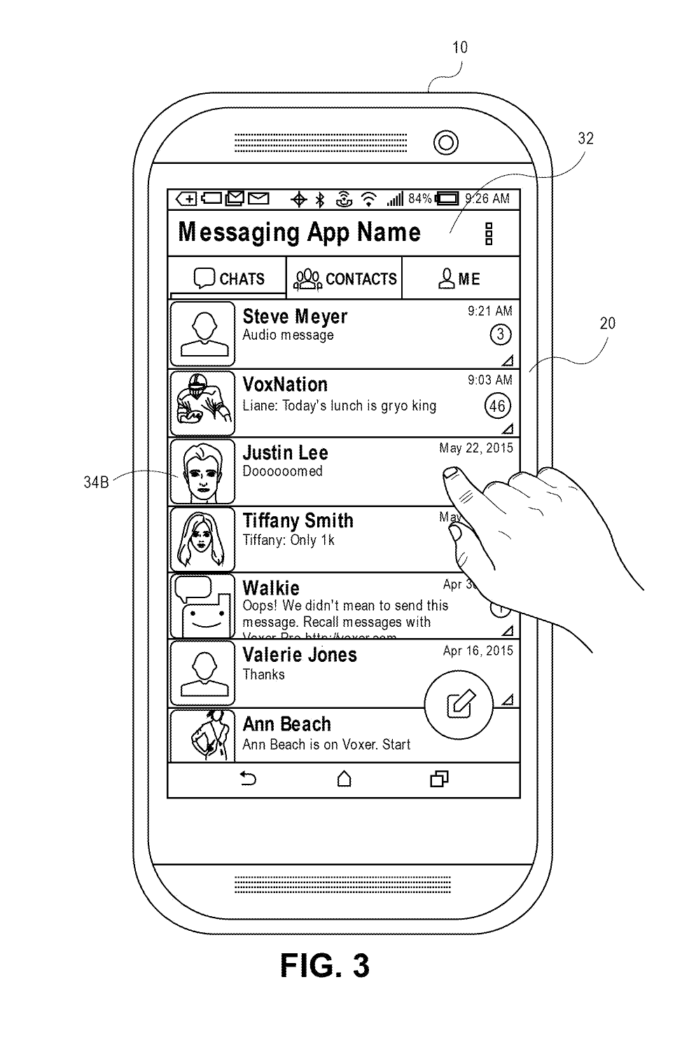

In another embodiment, the messaging application 32 includes a chat selection module, which inserts a video message including the recorded and saved video clip into one or more selected chats respectively. Referring to FIG. 3, the user of the device 10 is shown selecting another chat. In this particular example, a chat 34B with Justin Lee is selected. By selecting this chat, the chat selection module will retrieve the saved video clip from memory, insert the video clip into a video message, and send and insert the video message into the history of the chat with Justin Lee.

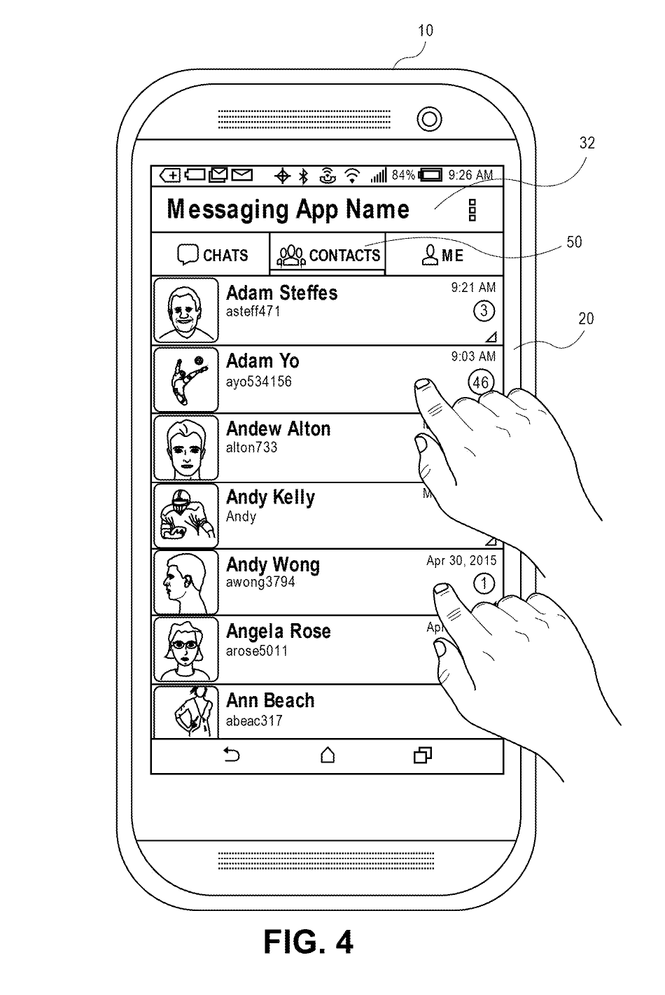

In yet another embodiment, the messaging application 32 may also include a contact selection module for selecting one or more contacts, among a list of contacts, and sending the video message containing the video clip to the selected one or more contacts. Referring to FIG. 4, a list of contacts 50 of the user of device 10 is illustrated. By selecting one or more contacts from the list 50, the contact selection module will retrieve the saved video clip from memory, insert the video clip into a video message, and send the video message to the one or more selected contacts. In the particular example shown, contacts Adam Yo and Andy Wong are selected. As a result, they will each receive the video message.

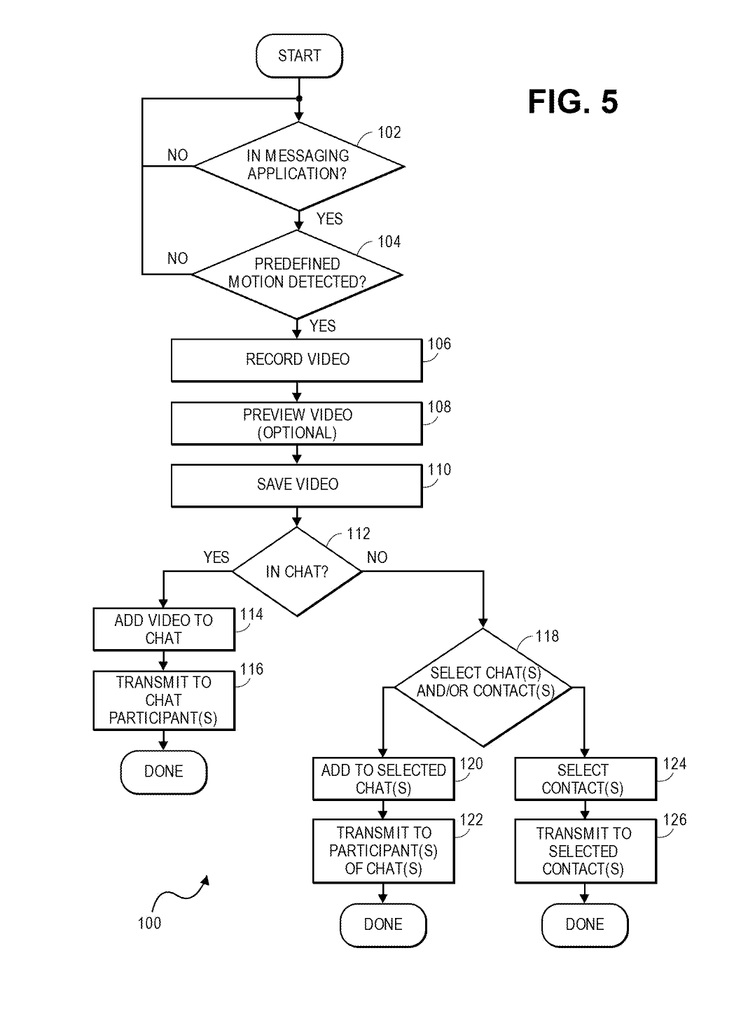

Referring to FIG. 5 a flow diagram 100 illustrating non-exclusive operational steps of the messaging application is shown. In the initial step, the messaging application 32 continually determines if the application is open and actively running on the device 10 (step 102). If yes, then the messaging application 32, in cooperation with the sensor(s) 24, determines if the predetermined motion has been detected. If yes, then the video camera 16 is activated, enabling the user to record a video clip (step 106), optionally preview the video clip (step 108), and then save the video clip (step 110). Thereafter, in decision 112, it is determined if a chat is opened and active. If yes, then a message containing the video is created, added to the active chat (step 114) and sent to the chat participant(s) (step 116). Alternatively, if there opened and active chat, then in decision 118 it is determined if a chat(s) and/or contact(s) has been selected. If one or more chat(s) is selected, then the video message is added to the chat(s) in step 120 and transmitted to the chat(s) participant(s) in step 122. If one or more contact(s) is selected (step 124), then the video message is sent to the selected contact(s) in step 126.

While the invention has been particularly shown and described with reference to specific embodiments thereof, it will be understood by those skilled in the art that changes in the form and details of the disclosed embodiments may be made without departing from the spirit or scope of the invention.

For example, it should be understood that the ability to create and send a video message within a messaging application as described herein is by no means limited to the Voxer application. Rather, the present invention as described herein may be implemented with any text messaging application, any voice messaging application, or any voice and text messaging application, such as but not limited to conventional email, WhatsApp, Viber, HeyTell, and Snapchat.

Furthermore, although the predefined motion from portrait to landscape mode for triggering the video function is provided, it should be understood that this motion should not be construed as limiting in any manner. On the contrary, various other motions for triggering the video function may be used, such as rotating the device 10 from landscape to portrait, a circular motion, a to and fro motion, a side-to-side motion, an up and down motion, or any other motion may be used.

Thus, the specific embodiments of the invention described herein should not be construed as limiting, but rather, mere examples of how the present invention may be implemented. It is therefore intended that the invention be interpreted to include all variations and equivalents that fall within the true spirit and scope of the invention.

What is claimed is:

1. A messaging application embedded in a non-transitory computer readable medium and intended to run on a mobile communication device configured to be connected to a network, the messaging application comprising:
a chat module enabling participation in a messaging chat, the messaging chat including a string of one or more messages sent between participants; and
a video module configured to interact with a video camera on the mobile communication device,
the messaging application further responsive to a sensor that senses a predefined motion of the communication device, and in response to the sensing of the predefined motion, the messaging application further configured to:
(a) record a video clip;
(b) create a video message containing the video clip; and
(c) insert the video message containing the video clip into the string of one or more messages sent between the participants of the messaging chat.

2. The messaging application of claim 1, wherein the predefined motion sensed by the sensor is a rotation of the communication device from a portrait orientation to a landscape orientation.

3. The messaging application of claim 1, further comprising a record function for selectively recording the video clip.

4. The messaging application of claim 1, further comprising a preview function for selectively previewing the recorded the video clip.

5. The messaging application of claim 1, further comprising a save function for saving the video clip and automatically inserting the video message containing the video clip into the string of messages of the messaging chat.

6. The messaging application of claim 1, wherein the chat module further enables participation in multiple messaging chats, the multiple chats each including a string of one or more messages sent between participants of the multiple messaging chats respectively.

7. The messaging application of claim 1, further comprising a chat selection module for inserting the video message containing the video clip into one or more selected messaging chats respectively.

8. The messaging application of claim 1, further comprising a contact selection module for selecting one or more contacts among a list of contacts and for sending the video message containing the video clip to the selected one or more contacts.

9. The messaging application of claim 1, wherein the messaging application is configured to transmit and/or receive, in addition to the video message one or more of the following types of messages:
text;
voice; or
images or photos.

10. The messaging application of claim 1, wherein the predefined motion comprises motion of the mobile communication device in one of the following:
(a) from a portrait orientation to a landscape orientation;
(b) from a landscape orientation to a portrait orientation;
(c) a circular motion;
(d) an up/down motion;
(e) a side-to-side motion; or
(f) to and fro motion.
